(19) United States
(12) Patent Application Publication
(10) Pub. No.: US 2017/0006490 A1
(43) Pub. Date: Jan. 5, 2017

(54) SENSOR NETWORK FOR REPORTING BASED ON TRIGGER OF EVENT LIBRARY

(71) Applicant: ZILLIONSOURCE TECHNOLOGIES CO.,LTD., Shanghai (CN)

(72) Inventors: LONGQIANG SHEN, Shanghai (CN); HONGQIANG HUANG, Shanghai (CN)

(21) Appl. No.: 15/113,166

(22) PCT Filed: Jan. 22, 2015
(86) PCT No.: PCT/CN2015/071269

§ 371 Date: Jul. 21, 2016

(30) Foreign Application Priority Data
Jan. 26, 2014 (CN) 2014-10036948.2

(51) Int. Cl. H04W 24/10; H04L 12/24; H04W 52/02; H04W 24/08

(52) U.S. Cl. CPC H04W 24/10; H04W 24/08; H04L 41/08; H04W 52/0203; H04W 84/18

(57) ABSTRACT

Disclosed is a sensor network for reporting based on the trigger of an event library, comprising a network and a monitoring terminal. The monitoring terminal is provided with a sensor unit, a data processing unit, a communication unit and a power source, wherein the sensor unit is connected to the data processing unit and is used for sending the data collected by the sensor unit to the data processing unit; the data processing unit communicates with the network through the communication unit; and the power source is used for supplying power. The data processing unit comprises an event library, wherein an event to which the system needs to respond in real time and a response method corresponding to the event are stored in the event library; when the event is not triggered, the sensor unit conducts high-density collection on the data and stores same in the data processing unit, and the data is uploaded at regular time intervals or, when the network is queried through an instruction, the data is uploaded in batches, thereby reducing the power consumption of the sensor network; and when the event is triggered, the sensor network preferentially processes the event, thereby guaranteeing timeliness.

### CROSS-REFERENCES TO RELATED APPLICATIONS

This application is a national stage application of PCT Patent Application No. PCT/CN2015/071269, filed on Jan. 22, 2015, which claims priority to Chinese Patent Application No. 201410036948.2, filed on Jan. 26, 2014, the content of all of which is incorporated herein by reference.

### FIELD OF THE INVENTION

The present invention relates to the field of information transmission technologies, and more particularly, to a sensor network with data submissions triggered by configurable events.

### BACKGROUND

Data submission is an essential part of a sensor network, especially for a wireless sensor network, as data submission strategy has important implications on both data collection frequency and power consumption.

In order to achieve a real-time submission of a large amount of monitoring data, an existing sensor network employs multiple transmission modes: when possible, a wire connection is used for a real-time data submission; for a wireless sensor network, a relay-and-amplify method may be adopted; However, for a wireless mobile sensor network, due to strict limits on power consummations of the mobile devices, it is not possible to maintain a real-time data collection and submission over an extended period of time. A compromise approach is to collect data on a real-time basis, cache the data, and then submit the data in batches according to some fixed schedule with relatively long time intervals, or when a user inquiry is received by a data collecting device. Such an approach does not maintain continuous wireless communication, and effectively cuts back the power consumption.

For existing sensor networks, there are inadequacies in data submission strategies:

In the case of a wired data transmission, due to the limitations of a physical cable, the transmission distance is often limited, and cabling also implies high cost associated with data submission.

In the case of a wireless transmission system using the relay-and-amplify method, it is possible to achieve real-time submission of monitoring data over a long distance wirelessly. However, adding a plurality of relay stations increases the complexity of the system, thus quickly pushes the cost up.

In the case of wireless mobile devices, relying on a data caching method and utilizing a relatively low submission frequency may serve the purpose of reducing power consumption, but at the same time defeat the purpose of real-time intelligence and quick response. Such a compromise is therefore only suitable for occasions where real-time data and fast response are not required.

Therefore, the prior art needs to be improved and developed.

### BRIEF SUMMARY OF THE DISCLOSURE

According to above mentioned defects in the prior arts, the purpose of the present invention to solve the present technical problems by: developing data submission strategies for sensor networks, achieving collection and processing of real-time intelligence, maintaining device power consumption at the minimum, and facilitating widespread applications of mobile sensor devices.

In order to achieve the above said purposes, the following technology protocols are adopted in the present invention:

A sensor network for reporting based on trigger of an event library, comprises of a network and a monitoring terminal; the monitoring terminal is provided with a sensor unit, a data processing unit, a communication unit and a power source; the sensor unit is connected to the data processing unit, and is used for sending data collected by the sensor unit to the data processing unit; the data processing unit communicates with the network through the communication unit; and the power source is used to supply power to the sensor unit, the data processing unit and the communication unit; wherein, the data processing unit comprises of an event library, which stores a plurality of events to which the system needs to respond in real time, and a set of response actions corresponding to each event is also stored in the event library; when an event is not triggered, the sensor unit conducts a high-frequency data collection and stores such data in the data processing unit, and the data will be submitted in a batch either at fixed time intervals, or when the network is queried through an instruction, thereby the power consumption for the sensor network are reduced; and when an event is triggered, the sensor network will process the event in real time, thereby guarantee that actionable intelligence is generated without delay.

A data reporting mechanism of the proposed sensor network comprises of the following steps:

1) Initiation and configuration of the sensor network Initiating and configuring directly through the monitoring terminal's internal logic, or through commands sent from the network to the monitoring terminal; the information for configurations may comprise of: a data collection frequency of the sensor, a plurality of parameters needed for algorithm of the data processing unit, a plurality of communication mechanisms of the communication unit;

2) Initializes the event library:

Initializing the event library through the network or the monitoring terminal by the user; at the first time when the sensor network is used, the event library will be downloaded and installed through the network; if the event library has already been downloaded and installed by the sensor network, the version status of the event library will be checked to see if it is the latest version and if it needs to be brought up-to-date;

3) Determines if an event in the event library is occurring or not:

Detects the status of each component in the sensor network, and compares with the events stored in the event library; if they match, a set of response actions will be initiated according to the corresponding responding methods defined in the event library; if there is no event occurring or an event response has been completed, the collected data will be saved into a data storage area in the data processing unit;

4) Submits data:

Data saved in the data processing unit are submitted in two ways: submitted in a batch, either when the fixed time interval arrives, or when the network sends a command for queries.

Further, the said events include: a measured value by the sensor unit is over limit, a tendency of the value measured by the sensor unit changes too fast or too slow, a sensor component fails, the power source is near depletion, the data storage area in the data processing unit is nearly full.

Further, the said response actions comprises of: sending out alarms when a measured value by the sensor unit is over limit, or when the measured value by the sensor unit changes too fast; reporting information related to component failures, when such a failure occurs; entering into a low power consumption mode, if the power source is near depletion; submitting the data actively, if the data storage area in the data processing unit is nearly full.

Comparing to the prior arts, the benefits of the present invention is as follows:

It is able to achieve high frequency data collection, and, through establishing and maintaining a dynamic event library, ensures real-time data submission for key events that require real-time response. When there are no alert-able events being triggered, data submission will be carried out at regular time intervals, which saves battery power and affords a much longer running time without a recharge for the wireless mobile devices. The present invention achieves real-time data submission for the generation of actionable intelligence without delay, and at the same time greatly extends the battery life of wireless mobile devices.

### BRIEF DESCRIPTION OF THE DRAWINGS

FIG. 1 illustrates a schematic diagram of a sensor network as provided in the present invention;

FIG. 2 illustrates a flow chart on the data submission process of the sensor network as provided in the present invention;

FIG. 3 illustrates a schematic diagram on an embodiment of the sensor network as provided in the present invention;

The reference numbers and corresponding parts are listed as follows:
Network
Monitoring terminal
Sensor unit
Data processing unit
Communication unit
Power source
201. Initiation unit
202. Unit to start and configure sensor network
203. Event library initialization unit
204 Unit for detecting and determining event occurrences
205. Events responding unit
206. Data storage unit
207 Finishing unit

### DETAILED DESCRIPTION

The present invention provides a sensor network for reporting based on trigger of an event library. In order to make the purpose, technical solution and the advantages of the present invention clearer and more explicit, further detailed descriptions of the present invention are stated here, referencing to the attached drawings and some embodiments of the present invention. It should be understood that the detailed embodiments of the invention described here are used to explain the present invention only, instead of limiting the present invention.

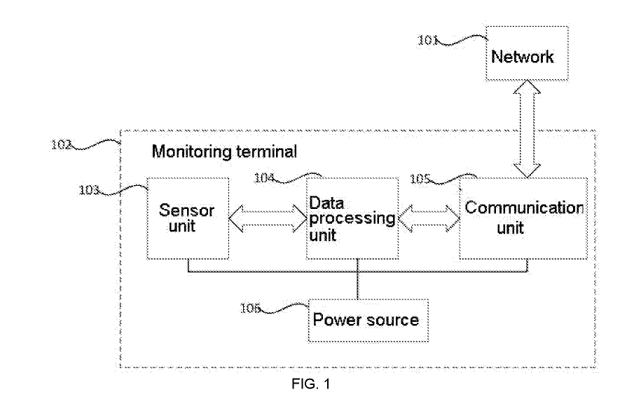

Referencing to FIG. 1, a sensor network as described in the present invention, comprises of two parts: a network 101 and a monitoring terminal 102. Within the monitoring terminal 102, a sensor unit 103 collects all relevant data, including a plurality of environmental parameters such as temperature, humidity, light exposure, vibration, speed, GPS/BDS (BeiDou Navigation Satellite System) and more, then sends to a data processing unit 104. The data processing unit 104 communicates with the network 101 through a communication unit 105. A power source 106 is used to supply power to the sensor unit 103, the data processing unit 104 and the communication unit 105.

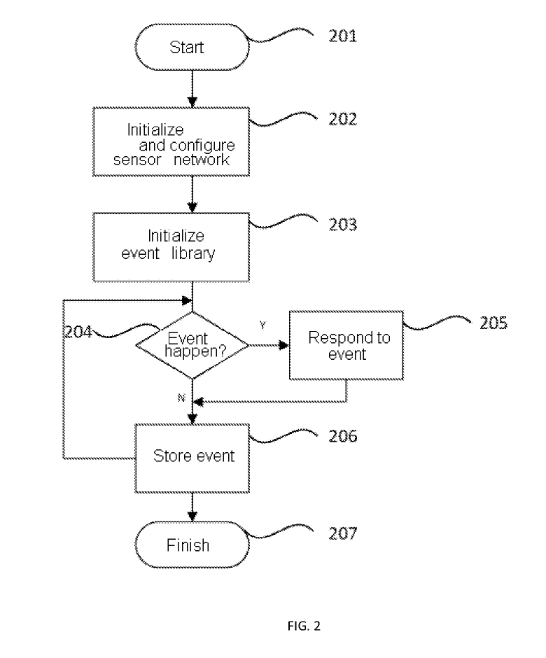

Referencing to FIG. 2, wherein, 202 is a unit for initiating and configuring the sensor network, and it can be started and configured directly through the monitoring terminal 102, or through remote commands sent from the network to the monitoring terminal 102. Configurations may comprise of, for example, data collection frequency of the sensor, a plurality of parameters needed for algorithms of the data processing unit, a plurality of communication mechanisms of the communication unit, and more.

In order to solve the problems in the prior art, that is, a pretty high power consumption persists when submitting data continuously in real time, and untimely data gathering and slow response to key events when submitting data only at fixed time intervals, the present invention adopts a set of data submission strategies based on the occurrences of events, which are dynamically maintained in an event library.

When there are no occurrences of events, the sensor network will conduct a high-frequency data collection and stores the data in the data processing unit 104. When a fixed time interval arrives, or the network 1 issues a command to the monitoring terminal 102 for inquires, communication will be initiated and data will be submitted in a batch.

In order to achieve a real-time performance of the system for any events of interests, the present invention introduces an event library. The event library resides in the data processing unit 104, and is jointly maintained by the data processing unit 104 and the network 101.

The event library contains definitions of a plurality of events that require the system to respond on a real-time basis. For example, a measured value by the sensor unit is over limit, or a measured value changes too fast or too slow, a sensor unit fails, the battery power is too low, a data storage area in the data processing unit 104 nearly runs out, and so on.

The event library also defines a plurality of responding actions for the above said events. For example, sending out alarms to a group of recipients if a measured value by the sensor unit is over limit, or a measured value changes too fast or too slow; reporting debugging information when sensor unit failures occur; entering into a low power consumption mode if the battery power is near depletion; submitting data immediately if the data storage area in the data processing unit is almost full.

The event library is dynamically maintained. That is, events can be edited, added or deleted based on the changing situation. This is achieved either through the interactive communication between the monitoring terminal 102 and the network 101, or through programmable logic residing in the monitoring terminal 102.

203 refers to the initial event library. A user may initialize the event library through the network 101 or the monitoring terminal 102. When a sensor network is used for the first time, an event library will be downloaded from the network and installed. If an event library has already been downloaded and installed, its version status is checked each time when the sensor terminal communicates with the network, and library update is done if the version is not up-to-date.

204 is the unit that determines if an event in the event library has occurred or not. If an event occurs, it will be processed by the event response unit 205. For example, if the event that the temperature is raising too fast is occurring, the event response unit 205 will execute response actions and send out alarms right away.

206 is a data storage unit. When there are no events occurring, or an event response has been completed, the collected data will be stored into a data storage area after being processed by the data processing unit 104.

Through the introduction of the event library, the system is capable of responding to any events of interests in real time, thus providing actionable intelligence without delay; when there are no events triggered, the system uses data cache and submits data at fixed time intervals, effectively lower the power consumption to a minimum and maximize the battery life of mobile wireless sensor devices.

### Implementation:

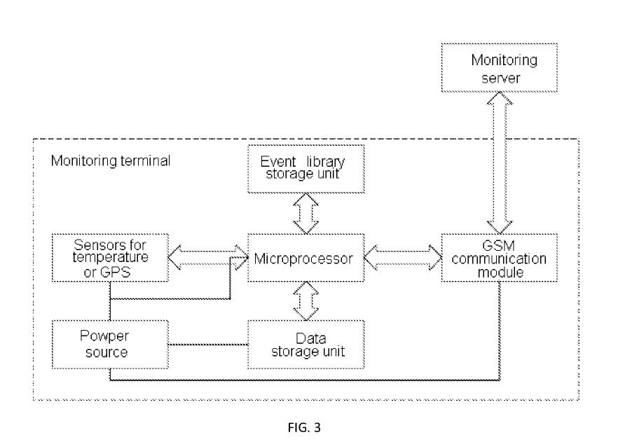

Showing as FIG. 3, which is a transportation monitoring system for a refrigerated moving vehicle. It is of interest to us to monitor both the refrigeration temperature and the vehicle location information during transportation of the refrigerated cargo.

The sensors for temperature and GPS/BDS collect temperature data in the refrigeration compartment and the location data of the vehicle, and then submit to a microprocessor within the monitoring terminal.

The remote monitoring computer server and the microprocessor within the monitoring terminal jointly maintain the event library. The event library contains both definitions of various events and the response actions to be triggered for each event. For example, the events may include that the temperature in the refrigerator should not exceed a preset value, otherwise, alarms will be dispatched; positions from the GPS/BDS should not be far off from the preset transportation routes, otherwise, users will be alerted.

The microprocessor processes the data collected by the sensors, and checks against the event library to determine if there are any events being triggered. If there are no events triggered, the microprocessor will save the data into the data storage unit, before submitting to the remote monitoring server through a plurality of communication channels including mobile communication networks such as GSM/GPRS/WCDMA/LTE, satellite communication networks such as Iridium/maritime satellite/BDS and more, as well as data networks such as Ethernet, WiFi and LAN. If there are any events triggered, the microprocessor will respond according to the actions defined in the event library. The event library can be updated through commands from the monitoring server or internal logic of the sensor terminal. The power source unit supplies power to each unit of the sensor terminal.

The above description has stated the basic principles and main features of the present invention, as well as the advantages of the present invention. Ordinary technical personnel in this field should understand that, the application of the present invention is not limited to the embodiments listed above, what described in the above listed embodiments and descriptions may be applied to explain the principles of the present invention only, ordinary technical personnel in this field may improve or change the applications according to the above descriptions, all of these improvements and transforms should belong to the scope of protection of the present invention. The scope of protection of the present invention is defined by the appended claims of the present invention and the equivalents thereof.

What is claimed is:

1. A sensor network for reporting based on trigger of an event library, comprises of a network and a monitoring terminal; the monitoring terminal is provided with a sensor unit, a data processing unit, a communication unit and a power source; the sensor unit is connected to the data processing unit, and is used for sending data collected by the sensor unit to the data processing unit; the data processing unit communicates with the network through the communication unit; and the power source is used to supply power to the sensor unit, the data processing unit and the communication unit; wherein, the data processing unit comprises of an event library, which stores a plurality of events to which the system needs to respond in real time, and a set of response actions corresponding to each event is also stored in the event library; when an event is not triggered, the sensor unit conducts a high-frequency data collection and stores such data in the data processing unit, and the data will be submitted in a batch either at fixed time intervals, or when the network is queried through an instruction, thereby the power consumption for the sensor network are reduced; and when an event is triggered, the sensor network will process the event in real time, thereby guarantee that actionable intelligence is generated without delay.

2. A reporting method of the sensor network according to claim 1, wherein, it comprises of the following steps: 1) initiates and configures the sensor network: initiating and configuring directly through the monitoring terminal's internal logic, or through commands sent from the network to the monitoring terminal; the information for configurations may comprise of: a data collection frequency of the sensor, a plurality of parameters needed for algorithm of the data processing unit, a plurality of communication mechanisms of the communication unit; 2) initializes the event library: initializing the event library through the network or the monitoring terminal by the user; at the first time when the sensor network is used, the event library will be downloaded and installed through the network; if the event library has already been downloaded and installed by the sensor network, the version status of the event library will be checked to see if it is the latest version and if it needs to be brought up-to-date; 3) determines if an event in the event library is occurring or not: detects the status of each component in the sensor network, and compares with the events stored in the event library; if they match, a set of response actions will be initiated according to the corresponding responding methods defined in the event library; if there is no event occurring or an event response has been completed, the collected data will be saved into a data storage area in the data processing unit; 4) submits data: data saved in the data processing unit are submitted in two ways: submitted in a batch, either when the fixed time interval arrives, or when the network sends a command for queries.

3. The sensor network for reporting based on trigger of an event library according to claim 2, wherein, the events include: a measured value by the sensor unit is over limit, a tendency of the value measured by the sensor unit changes too fast or too slow, a sensor component fails, the power source is near depletion, the data storage area in the data processing unit is nearly full.

4. The sensor network for reporting based on trigger of an event library according to claim 2, wherein, the response actions comprises of: sending out alarms when a measured value by the sensor unit is over limit, or when the measured value by the sensor unit changes too fast; reporting information related to component failures, when such a failure occurs; entering into a low power consumption mode, if the power source is near depletion; submitting the data actively, if the data storage area in the data processing unit is nearly full.
